(19) United States
(12) Patent Application Publication
(10) Pub. No.: US 2010/0239739 A1
(43) Pub. Date: Sep. 23, 2010

(54) APPARATUS AND METHOD FOR ENHANCING FOOD PRODUCT OVERRUN PRODUCED IN FOOD PROCESSING SYSTEM OR APPARATUS

(76) Inventors: Sean A. Pendergast, Berlin, MA (US); Steven Moysey, South Grafton, MA (US)

Correspondence Address: CESARI AND MCKENNA, LLP, 88 BLACK FALCON AVENUE, BOSTON, MA, 02210, US

(21) Appl. No.: 12/712,525

(22) Filed: Feb. 25, 2010

Related U.S. Application Data
(60) Provisional application No. 61/155,447, filed on Feb. 25, 2009.

(51) Int. Cl. A23P 1/16

(52) U.S. Cl. 426/564

(57) ABSTRACT

The invention provides a technique for enhancing food product overrun. Specifically, the illustrative embodiment of the present invention provides a system having a base mix input assembly and a base mix delivery assembly. The input assembly comprises a gas input conduit connected to a gas supply source and a fluid junction, such as a crow's foot junction. The conduit delivers gas into the fluid junction so that the gas may be combined with a base mix supply. The base mix and gas flow through the fluid junction to blend the base mix with flavorings and to aerate the base mix. The base mix input assembly connects to a base mix delivery assembly via the fluid junction. The base mix delivery assembly includes a delivery tube connected to the fluid junction and a delivery tube outlet.

### CROSS-REFERENCE TO RELATED APPLICATIONS

The present application claims the benefit of U.S. Provisional Patent Application Ser. No. 61/155,447, which was filed on Feb. 25, 2010, by Sean A Pendergast, entitled APPARATUS AND METHOD FOR ENHANCING FOOD PRODUCT OVERRUN PRODUCED IN FOOD PROCESSING SYSTEM OR APPARATUS and is hereby incorporated by reference.

### BACKGROUND OF THE INVENTION

1. Field of the Invention

The present invention relates generally to the processing of one or more food product ingredients and more particularly, to an apparatus and method for enhancing overrun of food products produced by food processing systems and methods.

2. Background Information

The term “overrun” as applied to a food product indicates the change in density undergone by a given mass of the food product because of aeration. In particular, processing a mixture of ingredients to produce ice cream and/or frozen yogurt may include aerating one or more ingredients during processing, including, for instance, a base mix blended with one or more flavorings and/or additives, in order to produce sufficient overrun with a desirable texture. Ensuring a proper amount of overrun is critical in food processing because variations in overrun of aerated ingredients will affect the quality of finished products.

### SUMMARY OF THE INVENTION

The invention provides a technique for enhancing food product overrun produced via a food processing and dispensing system. Specifically, the illustrative embodiment of the present invention implements a system having a base mix input assembly and a base mix delivery assembly. Illustratively, the base mix input assembly comprises a gas input conduit connected to a gas supply source on one end and a fluid junction, such as a crow's foot junction, on the opposite end. The gas input conduit delivers gas into the fluid junction from the gas supply source so that the gas may be combined with a base mix supply, e.g., a liquid food product ingredient(s) that the fluid junction receives from one or more sources. The base mix input assembly connects to a base mix delivery assembly via an intake port connected to the fluid junction. The base mix delivery assembly includes a delivery tube which surrounds the intake port on one end. On the opposite end of the delivery, tube is a outlet for dispensing a blended aerated food product.

In order to enhance the overrun of food products produced by the food processing and dispensing system, the present invention utilizes one or more protrusions and/or one or more flow disruption baffles on the interior walls of the delivery tube to create a tortuous path along which the base mix flows as it moves through the delivery tube. This tortuous path agitates the base mix and thereby enhances the aeration of the base mix and thus the overrun.

In the illustrative embodiment of the present invention, the delivery tube may also include a thermal jacket coaxially disposed around the delivery tube. The thermal jacket includes, within its interior, an internal channel which is configured to receive and circulate a temperature-affected media such as a thermal and/or cooling media, e.g., gas or liquid. By introducing the temperature-affected media into the internal channel of the thermal jack, the delivery tube is able to adjust and control temperatures of the delivery tube and therefore influence the temperature of the aerating base mix as it flows through the delivery tube. For example, if the jacket receives cooling media to lower temperatures of the delivery tube, the base mix will be cooled as it flows through the delivery tube.

Additionally, in further illustrative embodiments, aeration gas that the input conduit delivers to the fluid junction may be pre-conditioned to a lower temperature. Thus, when the time the gas interacts with the base mix the cooled gas will help further decrease the temperature of the base mix. The input conduit thereby delivers cooled or chilled aeration gas to the fluid junction while aerating the base mix.

In yet another embodiment of the of the present invention, one or more inlets delivering base mix to the fluid junction, and/or one or more restrictors controlling the delivery of the base mix to the fluid junction, may be designed to have narrow cross sections or diameters. By narrowing cross sections or diameters of the inlets and/or restrictors, the present invention increases the velocity at which the base mix is delivered into the fluid junction. Increased velocity of base mix flow into and through the fluid junction helps to enhance aeration of the base mix, and thus the overrun produced.

In still another embodiment of the invention, a pump, such as a reciprocating compressor or diaphragm pump may be operatively connected to the gas supply source to deliver pulsating streams of aeration gas into the into the fluid junction through the gas conduit. Such pulsating gas stream(s) enhances agitation of the base mix when combining with the base mix thereby further enhances aeration of the base mix and thus the amount of overrun produced.

### BRIEF DESCRIPTION OF THE DRAWINGS

The invention description below refers to the accompanying drawings, of which:

FIG. 1 is a schematic diagram of an illustrative embodiment of the present invention including an apparatus to enhance product overrun produced in a food processing system or apparatus and thus control the amount of overrun produced;

FIG. 2 is a cross-sectional view of the base mix delivery tube of the illustrative embodiment of the present invention shown in FIG. 1;

FIG. 3 is flow diagram illustrating an illustrative embodiment of the present invention including a method for enhancing aeration and food product overrun in a food processing system.

### DETAILED DESCRIPTION OF AN ILLUSTRATIVE EMBODIMENT

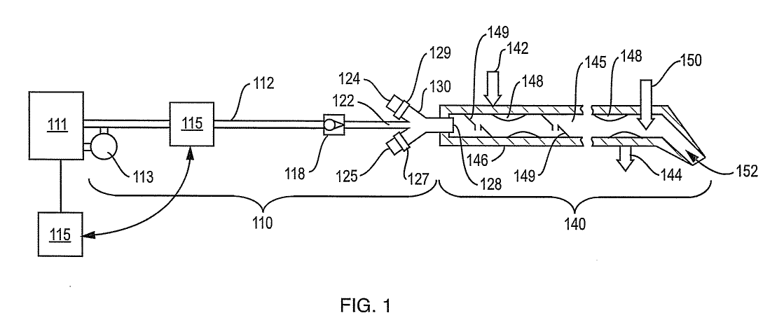

FIG. 1 illustrates an overrun enhancing system 100 for processing and aerating food product ingredients or food product intermediates to produce chilled or at least partially frozen food products, including, but not limited to, ice cream, frozen yogurt, and slushes. The system 100 may be incorporated or integrated with any system, apparatus, or method for producing at least partially frozen food products. For example, the embodiments of the invention disclosed herein may be illustratively incorporated with and/or implemented by one or more of the systems described in the following commonly owned copending patents and patent applications: U.S. Pat. Nos. 5,292,030, 5,433,967, 5,473,909, 5,603,257, 5,727,713, 5,758,571, 5,868,065, 6,698,228, 6,745,595, 6,907,741, 6,941,858, 6,952,928, 7,052,728, and 7,131,279; U.S. Patent Publication Nos.: 2006/0054614, 2006/0162348, 2006/0162347, 2006/0003065, 2007/0251260; and PCT Application Nos.: WO 92/02146, WO 03/041513, WO 04/019707, and WO 06/076733 the contents of each being hereby incorporated by reference in their entirety.

The invention, however, is not limited and envisions that the system 100 may be incorporated into or integrated with other food product processing apparatuses and methods. For purposes of disclosing the invention, the system 100 is described with reference to a food processing and dispensing apparatus and method for producing chilled or at least partially frozen food products, such as, ice cream, frozen yogurt, and slushes. However, the food processing and dispensing apparatus need not produce any chilled or at least partially frozen food products, such as, ice cream, frozen yogurt, and slushes. In addition, “base mix” refers to one or more ingredients, or mixtures thereof, that help to form a food product or food product intermediate.

The illustrative system 100 includes at least one base mix input assembly 110 and at least one base mix delivery assembly 140. The base mix input assembly 110 is constructed and arranged to inject a supply of base mix, or other ingredient(s), into the base mix delivery assembly 140 via an intake port 128 that that projects into and is defined by the base mix delivery assembly 140. In addition, the base mix input assembly 110 is constructed and arranged to provide aeration gas for blending with a base mix, e.g., including one or more ingredients for forming an ice cream, frozen yogurt or slush food product, in order to aerate the base mix. An illustrative gas supply source 111 is operatively connected to the base mix input assembly 110 to provide an aeration gas, e.g., pressurized and/or non-pressurized gas. Aeration gas may include air or any other non-toxic gas used to provide overrun or bulk or to other processed food products or ingredients.

The base mix input assembly 110 includes a gas input conduit 112 for connecting the base mix input assembly 110 to the gas supply source 111 on one end and a fluid junction 130, e.g. a crow's foot fluid junction, on the opposite end. The base mix input assembly 110 may also include a check value 118 operatively connected to the gas input conduit 112. The check value 118 is configured to adjust and control flow of gas from the gas source supply 111 to the fluid junction 130. The gas input conduit 112 and the check value 118 together form a path that delivers gas from the gas supply source 111 into the fluid junction 130 via an intake port 122. The fluid junction 130 defines intersecting inlets 124 and 125 for fluid flow therein. The inlets 124 and 125 and the junction 130 may be connected via base mix flow restrictors 129 and 127, respectively. Restrictors 129 and 127 help to increase velocity of the base mix as it flows into the fluid junction 130. Increased velocity of the base mix flow helps to initiate a strong turbulence in the base mix as it flows into and through the fluid junction 130. In turn, this turbulence helps to aerate a base mix before entering the base mix delivery assembly 140. Additional inlets and restrictors may be constructed and disposed along the intersecting inlets 124 and 125 and/or along the fluid junction 130 to further increase the velocity of the base mix into and through the fluid junction 130.

The base mix delivery assembly 140 includes a delivery tube 145, at least one flavoring injector 150, and a thermal jacket 146. The thermal jacket 146 coaxially surrounds the delivery tube 145. The thermal jacket 146 defines an internal channel 1-1-1 through which a temperature affected media such as a thermal and/or cooling media, e.g. gas or liquid, enters the thermal jacket 146 via a media inlet 142, circulates the temperature-affected media inside the internal channel 144, and exits the thermal jacket 146 via a media outlet 144. By circulating temperature-affected media through the thermal jacket 146, the system 100 is able to adjust and control the temperature of the base mix as it flows along and within the delivery tube 145, as described in further detail below.

For example, if the thermal jacket 146 contains a cooling medium, e.g., a refrigerant fluid, which circulates inside the jacket 146 and exits the jacket 146 at the media outlet 144, the system 100 can adjust and control temperatures within the delivery tube 145, and thereby lower temperatures of a base mix flowing though the delivery tube 145. For purposes of producing chilled or at least partially frozen food products, such as ice cream, frozen yogurt, and slushes, the system 100 is constructed and arranged to adjust and to control a range of temperatures from about 33° F. to about 40° F. The invention however is not limited in this respect and anticipates that the system 100 may be constructed and arranged to control any range of temperatures based on the type of food product being produced.

In the illustrative embodiment of the present invention, at least one flavoring injector 150 delivers one or more flavorings to the base mixture flowing through the delivery tube 145. The at least one flavoring injector 150 delivers a flavoring from a flavoring module or manifold (not shown) that receives one or more flavorings from a plurality of flavoring sources or containers and dispenses such flavorings as needed. Examples of flavoring modules and/or manifolds of this kind can be found the co-owned patents and patent application incorporated by reference above. In another embodiment, a plurality of flavoring injectors 150 may be connected to the delivery tube 145. In this illustrative embodiment, each injector 150 may be dedicated to at least one flavoring. Thus, the delivery tube 145 enables a base mix to blend with one or more delivered flavorings as the base mix flows through the delivery tube 145. Thus, once the base mix flows through the base mix delivery assembly a flavored base mix is delivered via a delivery tube outlet 152 to a second stage in the food production (not shown) for further processing or dispensing.

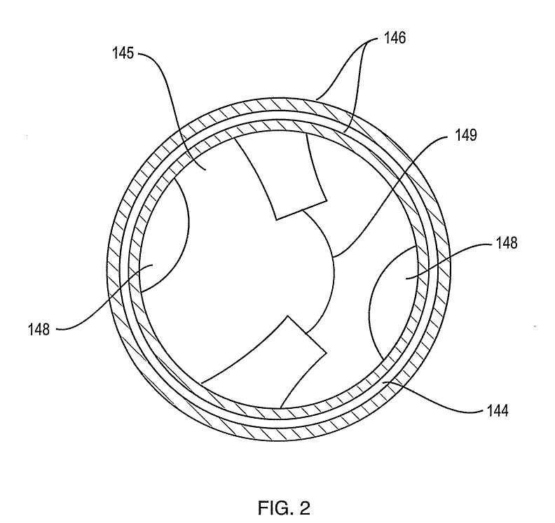

Referring to FIG. 2 and with further reference to FIG. 1, the base mix delivery tube 145 is defined along the interior walls by one or more protrusions 148 and/or one or more flow disruption baffles 149. The protrusions 148 and the flow disruption baffles 149 are disposed and configured to help to agitate a base mix as it flows through the delivery tube 145 in order to enhance aeration of the base mix. Aerating a base mix, as it pertains to novel aspects of the present invention includes combining gas, e.g., pressurized or non-pressurized gas from the gas supply source 111, with a base mix as it flows through the fluid junction 130 and/or the delivery tube 145, e.g., to increase the volume of the base mix.

In one embodiment, the at least one flavoring injector 150 may be disposed along the delivery tube 145, such that, as the base mix flows through the delivery tube 145, it may blend with a flavoring while at the same time being aerated with a supply of gas. In another embodiment of the present invention, the at least one flavoring injector 150 may be disposed along the delivery tube 145, such that, the flavoring injector 150 introduces a flavoring into an already aerated base mix flowing through the delivery tube 145.

In another embodiment of the present invention, the aeration gas supplied into the fluid junction 130 may be conditioned by a conditioning device 115 to any of a range of temperatures for lowering the temperature of the base mix as it flows through the inlets 124 and 125, such that, as the base mix is delivered into the fluid junction 130 is cool in the base mix delivery assembly it is cooled by the conditioned gas. The conditioning device 115 is operatively connected to the gas supply source to condition the gas within the gas supply source to a desired temperature within a range of temperatures. In another embodiment of the present invention, the conditioning device conditions the aeration gas as it flows through conduit 112 to the fluid junction 130. For example, if the purpose of conditioning the gas is to cool, the conditioning device may be any type of refrigeration system which allows the gas to be cooled within the gas supply source.

To further enhance aeration of the base mix, in one embodiment, the intake ports 124 and 125 and the restrictors 129 and 127, respectively, of the system, 100 may be designed as relatively narrow cross sections or diameters. Reduced cross sections of the ports 124 and 125 and restrictors 129 and 127 increase a velocity of the flow of the base mix as it flows into the fluid junction 130. This increased velocity, helps to initiate a strong turbulence in a base mix as it flows into and through the fluid junction 130. Thus, a base mix may begin aeration before entering the delivery tube 145.

The illustrative embodiment of the present invention may also employ a pump 113, e.g., a reciprocating compressor or diaphragm pump, connected with the gas supply source 111 to deliver gas into the fluid junction 130 via the input conduit 112 and even further enhance the aeration of the base mix. The system 100 may thereby take advantage of an aggressive “pulsing” action that the pump 113 creates in introducing gas directly into the inlet conduit 112 and the fluid junction 130. Pulsating gas turbulates or agitates the base mix flowing through the fluid junction 130 and thus the delivery tube 145 as well.

However, the illustrative system 100 of the present invention may be further configured and operative to heat and to thereby sanitize as least portions of the base mix input assembly 110 and/or the base mix delivery assembly 140, e.g., in contact with the gas, base mix, flavorings and/or other ingredients during processing. As noted above, the internal channel 144 of the thermal jacket 146 is configured to receive a warm or hot media, e.g., gas or liquid, via the media inlet 142 and to circulate such media through the thermal jacket 146 until it exits through the media outlet 144. The temperature of portions of the input and delivery assemblies 110 and 140 are increased to any of a range of temperatures for a certain duration, in order to kill microorganisms and to exterminate microbial molds along food contact surfaces to a level below the required food safety standards. The system 100 may execute periodically, e.g., every 24 hours. Such heating/sanitizing may thus be utilized to achieve scheduled cleaning/sanitizing of the above assemblies as is required by food safety standards.

For example, in one embodiment of the invention, at least portions of the base mix input assembly 110 and/or the base mix delivery assembly 140 in contact with gas, base mix, flavorings and/or other ingredients during processing, (e.g., portions of the gas inlet conduit 112, the fluid junction 130 and/or the delivery tube 145), may be constructed of food grade stainless steel tubing. In this embodiment, such portions of the base mix input assembly 110 and the base mix delivery assembly 140 would thus be non-disposable thereby requiring the system 100 to employ the thermal jacket 146 to circulate a thermal media to perform periodically in-place heating/sanitizing of these portions, as described above.

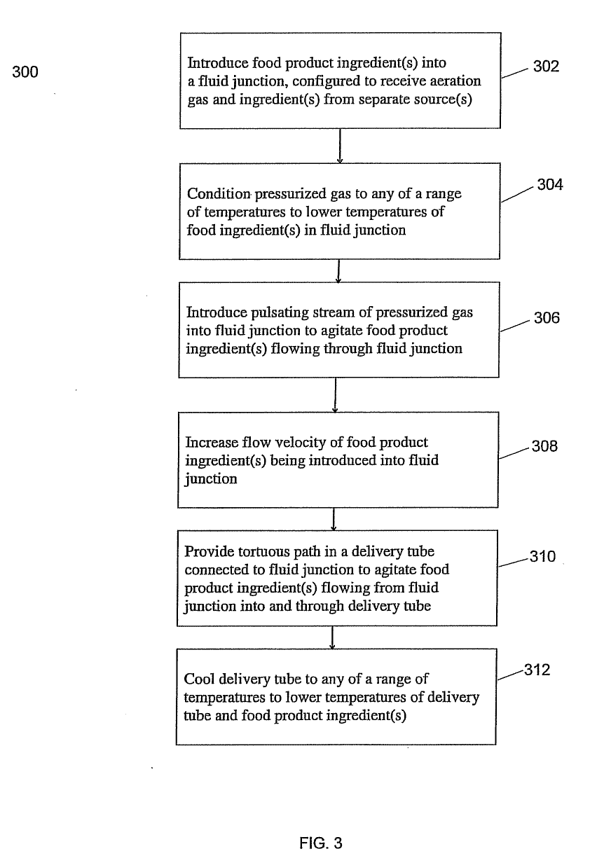

FIG. 3, with further reference to FIGS. 1 and 2, illustrates other aspects of the invention which provides an illustrative method 300 for enhancing aeration, and thus product overrun, in a food processing and dispensing system. The method 300, however, is exemplary only and is not limiting. The method 300 may be altered, e.g., by having steps added, removed or rearranged.

As shown in FIG. 3, at step 302, a base mix used to produce a food product, alone or in combination with one or more other ingredients, is introduced into the fluid junction 130 through one or more inlets 124 and 125. At step 304, the gas is conditioned via cooling mechanism 115 to any of a range of temperatures to help lower the base mix temperatures as the base mix and gas stream flow into and through the fluid junction 130 and the delivery tube 145. At step 306, the pump 113, operatively connected to the gas supply source 111, pulsates gas, e.g., pressurized or non-pressurized gas, into the fluid junction 130 via a inlet conduit 112. As noted above, pulsating the gas stream helps to turbulate or agitates the base mix as the base mix and gas stream flow into and through the fluid junction 130 and delivery tube 145. At step 308, the velocity at which the base mix is delivered into the fluid junction 130 by narrowing the cross sections or diameters of the intersecting inlets, 124 and 125 and/or the base mix restrictors 129 and 127 to a relatively narrow opening. The increased velocity thus helping to facilitate aeration of the base mix.

At step 310, a delivery tube 145 is provided having one or more protrusions 148 and/or one or more flow disruption baffles 149 to create a tortuous path along the interior walls of the delivery tube 145, thereby helping to turbulate or agitate the base mix as it flows through the delivery tube 145 and collides the protrusions 148 and/or baffles 149 within. At step 312, the delivery tube 145 may be chilled to any of a range of temperatures with receipt and circulation of a cooling media, e.g., a refrigerant fluid, into and through an internal channel 144 of the thermal jacket 146, such that, as a base mix flows through the delivery tube 145, heat will be transferred from the base mix to the thermal jacket 146, thereby lowering temperature of the base mix by the time it exits the delivery tube at delivery tube outlet 152.

Advantageously, the overrun enhancing system and methods help to lower temperatures of a base mix and thus enhance aeration of the base mix while at the same time blending flavorings and increasing overrun. Specifically, by providing a tortuous path along the interior of the base mix delivery tube, the tortuous path may turbulate or agitate a base mix as it flows through the delivery tube 145 thereby enhance overrun of the base mix. Additionally, the present invention also provides a means for cooling the base mix. Thus, the system 100 of the invention may combine one or more of the enhancements described above, including lowering temperatures of the fluid junction 130 and/or the delivery tube 145, utilizing high velocities of base mix flow into the fluid junction 130, pulsating the aeration gas, and structuring a tortuous path within the delivery tube 145, to help to enhance aeration of a base mix as it flows through the fluid junction 130 and/or the delivery tube 145.

Having thus described at least one illustrative embodiment of the inventions, various alterations, substitutions, modifications, and improvements in form and detail will readily occur to those skilled in the art without departing from the scope of the inventions. Such alterations, substitutions, modifications, and improvements are intended to be within the scope and spirit of the inventions. Other aspects, functions, capabilities, and advantages of the inventions are also within their scope. Accordingly, the foregoing description is by way of example only and is not intended as limiting.

In addition, in describing aspects of the invention, specific terminology is used for the sake of clarity. For purposes of description, each specific term is intended to at least include all technical and functional equivalents that operate in a similar manner to accomplish a similar purpose. In some instances where a particular aspect of the invention includes a plurality of system elements or method steps, those elements or steps may be replaced with a single element or step; likewise, a single element or step may be replaced with a plurality of elements or steps that serve the same purpose. Further, where parameters for various properties are specified herein for aspects of the inventions, those parameters can be adjusted or rounded-off to approximations thereof within the scope of the invention, unless otherwise specified.

What is claimed is:

1. An method for enhancing and controlling the amount of overrun produced by a food processing and dispensing system, the method comprising:
introducing a food product ingredient into a fluid junction configured to receive a gas and the food product ingredient, the gas and the food product ingredient received separate sources, both of which are operatively connected by the fluid junction;
introducing, via a pump, a pulsating stream of gas into the fluid junction, the pulsating gas introduced to agitate and aerate the food product ingredient introduced into the fluid junction before the food product ingredient enters a delivery tube;
flowing the food product ingredient and the gas through a delivery tube, the delivery tube having a tortuous path to agitate the food product ingredient, the gas and one or more flavorings, wherein the delivery assembly is connected to the fluid junction so that the base mix flows from the fluid junction and into the delivery tube; and
cooling the delivery tube via a thermal jacket surrounding the delivery tube to a temperature within a desired range of temperatures, the delivery tube having an internal channel for circulating a temperature affected media coaxially around the delivery tube, the cooled delivery tube lowering the temperature of the food product ingredient as it flows through the delivery tube and out an outlet.

2. The method of claim 1, further comprising conditioning the gas to a temperature within a desired temperature, the conditioned gas lowering the temperature of the base mix as the gas enters the fluid junction.

3. The method of claim 1, further comprising increasing a velocity at which the base mix enters the fluid junction by decreasing the cross sectional area of one or more inlets to the fluid junction and one or more restrictors connecting the inlets to the fluid junction.
